(19) United States
(12) Patent Application Publication
(10) Pub. No.: US 2014/0305026 A1
(43) Pub. Date: Oct. 16, 2014

(54) DEVICES, SYSTEMS, METHODS AND KITS FOR ATTRACTING CRABS OR LOBSTERS IN AN AQUATIC ENVIRONMENT

(71) Applicant: HIGHLINER PRODUCTS, LLC, New York, NY (US)

(72) Inventor: Kyle PEMBERTON, San Francisco, CA (US)

(73) Assignee: HIGHLINER PRODUCTS, LLC, New York, NY (US)

(21) Appl. No.: 14/251,339

(22) Filed: Apr. 11, 2014

Related U.S. Application Data
(60) Provisional application No. 61/810,872, filed on Apr. 11, 2013.

(51) Int. Cl. A01K 69/06

(52) U.S. Cl. CPC A01K 69/06
USPC 43/100

(57) ABSTRACT

Devices, systems and kits are described which provide a method for trapping crustaceans in an aquatic environment. The systems include receptacles for holding bait, with a lid to secure a soluble layer onto the receptacle. The soluble layer dissolves over time to allow the scent of the bait to be released in the aquatic environment to attract the target crustaceans.

### CROSS-REFERENCE

This application claims the benefit of U.S. Provisional Application No. 61/810,872, filed Apr. 11, 2013, which application is incorporated herein by reference.

### BACKGROUND OF THE INVENTION

In 2006, the commercial fishing industry generated over 185 billion dollars in sales and provided over two million jobs according to NOAA's Fisheries Service. See, New Economic Report Finds Commercial and Recreational Saltwater Fishing Generated More than Two Million Jobs National Oceanic and Atmospheric Administration, Jan. 6, 2009. While commercial fishing may offer an abundance of jobs, the pay can vary significantly from boat to boat, season to season. Crab fisherman Cade Smith was quoted in an article by Business Week as saying, “There was always a top boat where the crew members raked in $50,000 during the three- to five-day king crab season—or $100,000 for the longer snow crab season”. Kerry Miller, Worst Jobs with the Best Pay, Businessweek, Sep. 13, 2006.

Crustaceans, including crab and lobsters, rely primarily on chemoreception which is mediated by small sense organs occurring all over the body. Olfactory receptors are also present. Both types of receptor neurons respond mainly to small water-soluble molecules, such as amino acids. Chemoreception facilitates food detection, among other things, in the crustaceans. See, for example, M. Schmidt, et al. Neuronal Processing of Chemical Information in Crustaceans, Chapter 7, in Chemical Communication in Crustaceans (T. Breithaupt, et al. (eds.)) 2011.

A common practice for crab fishermen is to place a bait jar in a crap trap before setting the traps in the water. However, standard bait jars lose the majority of “scent” (i.e., the ability to attract crustaceans by releasing substance into the aquatic environment) after 6-8 hours of contact with ocean water. Once the scent is lost, crabs are no longer drawn to the trap. In order to continue the process of attracting and trapping crabs, the traps are drawn-up, jars are changed, and then placed back in the water. This process is time consuming and expensive and can reduce the amount of time the traps are in the water, potentially limiting the amount of crabs caught. This particularly becomes problematic as crab season progresses.

Currently, PVA bait bags are used for carp. See, for example, PVA Bags & Mesh available from resistance tackle (www.resistancetackle.com). The PVA bags dissolve and release the entire amount of bait at one time. Additionally, there are time release fish food blocks, such as those available from Aquamarine Guys (www.aquamraineguys.com). The fish food blocks slowly erode to deliver food to fish over time. Neither of these solutions are adaptable to the problem faced by commercial fisherman.

What is needed are systems, devices and mechanisms for cost effectively trapping crabs and crustaceans which enable fewer trips to collect or check on the traps wherein the odor from the bait is not released until a desired time.

### SUMMARY OF THE INVENTION

Systems, devices, kits and methods for trapping crabs or lobster in an aquatic environment are disclosed.

An aspect of the disclosure is directed to an assembly. Assemblies are configurable to comprise: a receptacle having a bottom, side walls and an opening at one end forming a cavity; a securement component having one or more apertures configured to engage the open end of the receptacle; a primary soluble layer having a target dissolution time, wherein the assembly is configured to securely contain a solid material within the receptacle protected from consumption by organisms and further wherein the primary soluble layer is configured to release a water soluble material from the solid material within the receptacle. Additionally, the receptacle is configurable to have a threaded opening and the securement component is configurable to having mating threads. A secondary soluble layer can be provided having a target dissolution time different that the dissolution time for the primary soluble layer. The primary soluble layer can be selected such that it has a target dissolution time selected from the following: 3 hours, 6 hours, 12 hours, 18 hours, 24 hours, 30 hours and 36 hours. Additionally, a mesh layer can be provided. Moreover, the solid material is bait. In at least some configurations, the soluble layer has a thickness from 0.25 mm to 25 mm. The soluble layer can comprise one or more of: gelatin, casein, biopolymer, plastic, cellulose acetate, polyhydroxyalkanoates, poly-butyl acetate mix, poly(lactic acid); poly(vinyl acetate); and poly(ester amide). Additionally, the soluble layer further comprises one or more of poly ethylene oxide, polyacrylamide, and hydrolyzed polyacrylamide.

Another aspect of the disclosure is directed to a system. The systems are configurable to comprise: a first receptacle having a bottom, side walls and an opening at one end forming a cavity; a first securement component having one or more apertures configured to engage the open end of the receptacle; a first primary soluble layer having a target dissolution time, a second receptacle having a bottom, side walls and an opening at one end forming a cavity; a second securement component having one or more apertures configured to engage the open end of the receptacle; a second primary soluble layer having a target dissolution time, wherein the first receptacle and second receptacle are configured to securely contain a solid material within the receptacle protected from consumption by organisms and further wherein the first primary soluble layer is configured to release a water soluble material from the solid material within the first receptacle at a first target dissolution time and the first secondary soluble layer is configured to release a water soluble material from the solid material within second receptacle at a second target dissolution time. further wherein the first target dissolution time is a time different. The first receptacle and second receptacle have a threaded opening and the first securement component and second securement component is configured to have mating threads. The primary soluble layer and secondary soluble layer can be selected such that it has a target dissolution time selected from the following: 3 hours, 6 hours, 12 hours, 18 hours, 24 hours, 30 hours and 36 hours. Additionally, a mesh layer can be provided. Moreover, the solid material is bait. In at least some configurations, the soluble layer has a thickness from 0.25 mm to 25 mm. The soluble layer can comprise one or more of: gelatin, casein, biopolymer, plastic, cellulose acetate, polyhydroxyalkanoates, poly-butyl acetate mix, poly(lactic acid); poly(vinyl acetate); and poly(ester amide). Additionally, the soluble layer further comprises one or more of poly ethylene oxide, polyacrylamide, and hydrolyzed polyacrylamide.

Still another aspect of the disclosure is directed to methods of attracting crustaceans. The methods comprise: selecting a soluble material having a target dissolution time; placing a solid material in a receptacle having a bottom, side walls and an opening at one end forming a cavity; selecting one or more soluble layers, wherein each of the one or more soluble layers has a target dissolution time; and securing the one or more soluble material layers to the opening of the receptacle using a securement component having one or more apertures configured to engage the open end of the receptacle. The method can further comprise the steps of: placing the assembled receptacle into a bait box; and placing the assembled receptacle and bait box into an aquatic environment.

Yet another aspect of the disclosure is directed to kits comprising one or more of each of the following: a receptacle having a bottom, side walls and an opening at one end forming a cavity; a securement component having one or more apertures configured to engage the open end of the receptacle; a screen sized to fit over the opening of the receptacle; bait; and one or more soluble layers having a target dissolution time.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-B are a perspective views of traps suitable for use in catching lobster or crab in an aquatic environment;

FIGS. 2A-B through 3A-C are configurations of bait jars suitable for use with a trap of FIG. 1;

FIGS. 4A-B is an alternative configuration of a bait jar;

FIG. 5 is a graph illustrating a bait odor release profile;

FIG. 6 illustrates the configuration of the system used for lab testing the system; and

FIG. 7 is a graph illustrating the results of blue dye absorbance.

### DETAILED DESCRIPTION OF THE INVENTION

In order to obtain a delayed release of bait there are a number of materials-based approaches that could be tried, primarily involving water soluble polymers.

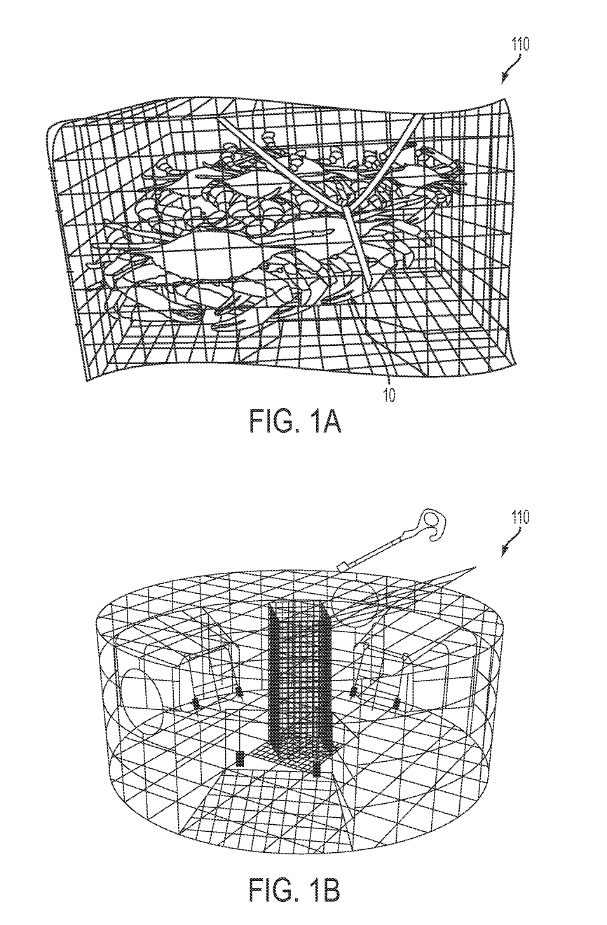

FIGS. 1A-B are a perspective views of bait boxes or traps suitable for use in catching lobster or crab. The traps 110 are have a cage formed from, for example, wire. The trap 110 can be square (FIG. 1A), rectangular, or cylindrical (FIG. 1B). The traps are configured so that bait is provided within the trap, which attracts target sea life (such as crabs 10 and lobsters). The crabs and lobsters are able to enter the trap to access the bait, but are not able to easily exit the trap. Sea water is able to freely flow through the trap when it is deployed. A variety of mechanism of making bait accessible are provided. Crab pots can be made from crab pot wire (24″ wide, 18-gauge with 1½″ mesh spacing.), 12′ of galvanized 11-gauge smooth wire, galvanized crab pot staples (or No. 4 hog rings.), one small sacrificial zinc anode, 6″ piece of shock cord (bungee cord), 7/32″ diameter, cull rings and plastic hook. Alternatively crab pots can be purchased already made.

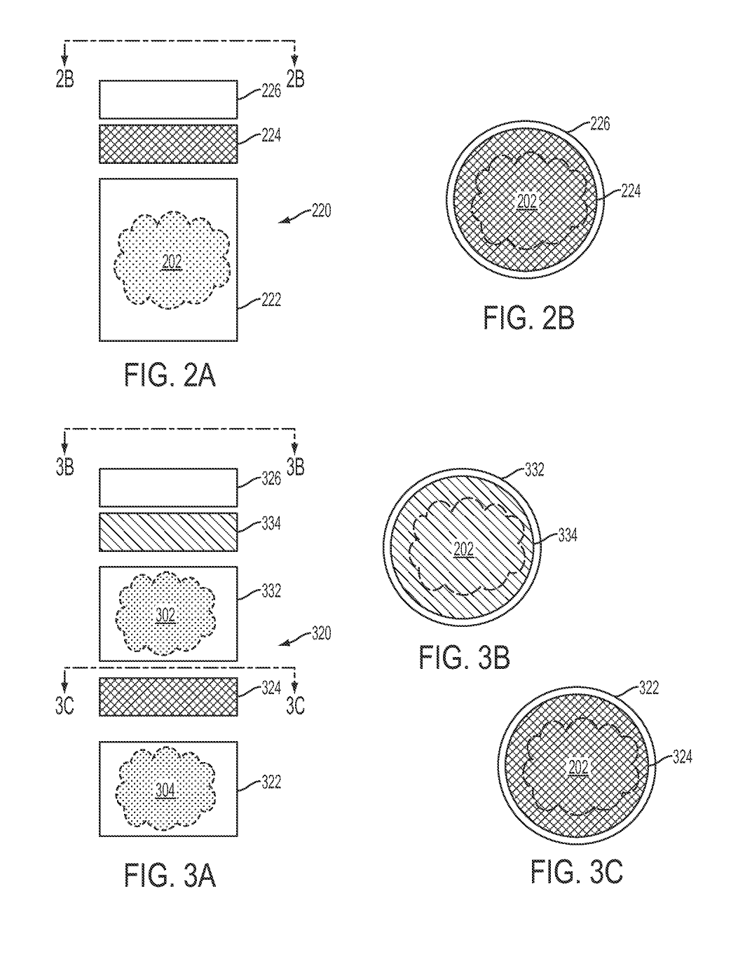

FIGS. 2A-B illustrates a configuration of a bait jar 220 suitable for use with a trap of FIG. 1. As shown in FIG. 2A, the bait jar 220 has a primary jar 222 which is configured to contain suitable bait 202 (fish guts, etc.) or material which would be attractive to the crabs or lobster. The primary jar has a soluble layer 224 which is secured to the bait jar 220 with a suitable securement device 226 such as a lid having an aperture in the top. The securement device secures the soluble layer to the bait jar. The securement device can include additional features to engage the soluble layer, if desired. Additional features include, for example, a mesh layer to protect the bait from being eaten by smaller marine life. As shown in FIG. 2B, which is a view taken from the point of 2B-2B in FIG. 2A, the securement device 226 has one or more apertures that expose the soluble layer to the environment (e.g., salt water). This allows the soluble layer to dissolve over time—which is determined by a variety of factors including, for example, the materials for the soluble layer, salinity of the water and temperature of the water.

The soluble layer ranges from 0.25 mm to 25 mm thick, more preferably 0.25-10 mm thick, and even more preferably 0.25 mm to 5 mm thick. Soluble layers can be formed from one or more of: gelatins and casein can be plasticized to form films or even encapsulate a delivery completely; starch-based biopolymers are cheap, digestible, and easily processed as plastics; cellulose-acetate is one of the oldest bioplastics, and is slowly biodegradable; a polyhydroxyalkanoates (PHA)-poly-butyl acetate (PBA) mix, PLA poly(lactic acid); PVA poly(vinyl acetate); PEA poly(ester amide). Additional components can include poly (ethylene oxide), polyacrylamide, and hydrolyzed polyacrylamide. Additionally, in some configurations, the soluble layer can comprise one or more layers.

FIGS. 3A-C illustrates a configuration of a bait jar 320 suitable for use with a trap of FIG. 1. As shown in FIG. 3A, the bait jar 320 has a primary jar 322 which is configured to contain suitable bait 302 (fish guts, etc.) or material which would be attractive to the crabs or lobster. The primary jar can be configured to provide an soluble layer 324 which is secured to the bait jar 320 with a suitable securement device. A secondary jar 332 is provided has an optional second soluble layer 334 which, if provided, can be different than the first soluble layer.

In one configuration, the primary bait jar 322 can have a threaded upper surface, which is configured to threadably engage the lower surface of the secondary jar 332. One or more apertures can be provided in the bottom surface of the secondary jar 332 to exposure the second soluble layer 334 to the environment, once the first primary layer has dissolved (if present) and the bait in the primary jar 322 has been exposed to the environment.

In one configuration, no secondary layer is provided, thus upon deployment, the bait in the secondary jar is immediately exposed to the environment and begins attracting crab or lobster. The primary layer begins to dissolve such that when the bait in the secondary jar has lost its attractiveness, the bait in the primary jar is exposed to the environment and begins to attract crab or lobster.

In another configuration, a secondary layer is provided, thus upon deployment, the secondary layer begins to dissolve. Once dissolved, the bait in the secondary jar is exposed to the environment and begins attracting crab or lobster. At this juncture, the primary layer begins to dissolve such that when the bait in the secondary jar has lost its attractiveness, the bait in the primary jar is exposed to the environment and begins to attract crab or lobster. The soluble layers can be made of the same material or different material. Even where the soluble layers are made from the same material, because the layers are exposed to the environment at different times, the result is that the bait protected by the soluble layer is exposed at different times.

As shown in FIG. 3B, which is a view taken from the point of 3B-3B along the top of the system in FIG. 3A, the securement device 326 has one or more apertures that expose the soluble layer to the environment (e.g., salt water). This allows the soluble layer to dissolve over time—which is determined by a variety of factors including, for example, the materials for the soluble layer, salinity of the water and temperature of the water. As shown in FIG. 3C, which is a view taken from the point of 3C-3C below the secondary jar in the system in FIG. 3A, the soluble layer is exposed to the environment through one or more apertures in the bottom surface of the secondary jar. This allows the soluble layer to dissolve over time at a delay from the time when the secondary layer 334 dissolves (if present).

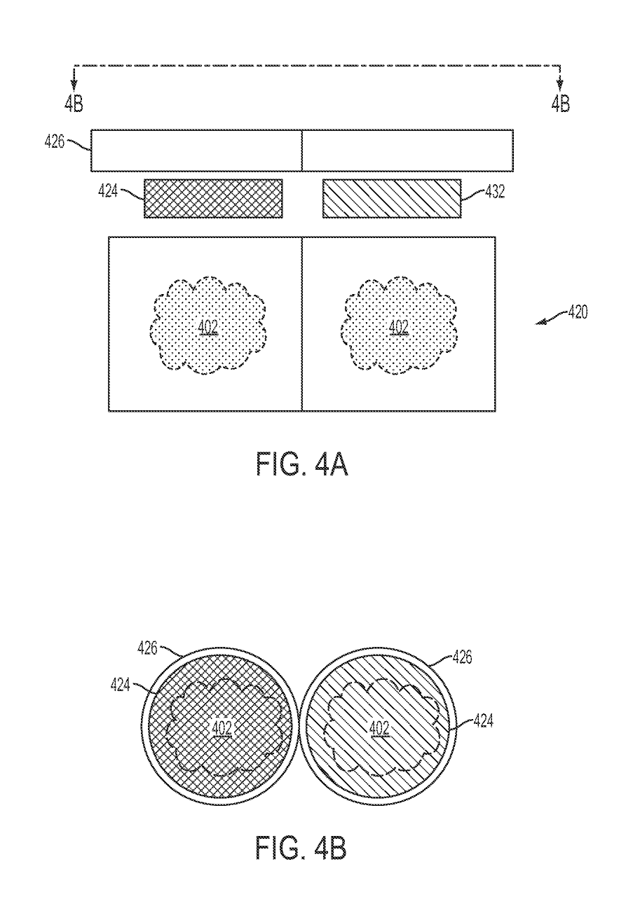

FIGS. 4A-B illustrates a configuration of a bait jar 420 suitable for use with a trap of FIG. 1. As shown in FIG. 4A, the bait jar 420 has a primary jar 422 which is configured to contain suitable bait 402 (fish guts, etc.) or material which would be attractive to the crabs or lobster. The primary jar can be configured to provide a soluble layer 424 which is secured to the bait jar 420 with a suitable securement device. A secondary jar 432 is provided adjacent the primary jar and has an optional second soluble layer 434 which, if provided, can be different than the first soluble layer.

In one configuration, the primary bait jar 422 and secondary bait jar 432 can have a threaded upper surface, which is configured to threadably engage one or more securement devices 326. One or more apertures can be provided in the securement device to exposure the soluble layers 424, 434 to the environment.

The bait jars can be inserted into a suitable bait box and then deployed by the fisherman. Soluble layers can be selected to alter the rate at which the bait in a compartment is made available in the environment, thus increasing the overall amount of time a bait box is attractive to the crabs or lobsters. By using dissolvable layers to delay exposure of the bait to salt water, the amount of time bait is attracting the crabs or lobsters can be increased from the current 6-8 hours, to 12-16 hours, 16-24 hours, and up to 36, 48, or 60 hours, depending upon the number of bait containers, the rate of dissolution of the soluble interface, the amount of time that passes before a soluble interface is exposed, etc.

Thus, for example, three bait jars having a primary bait container and a secondary bait container could be provided, where the first bait jar exposes bait in the primary jar immediately, and the secondary jar is exposed after the soluble layer is exposed for 6 hours. The second bait jar, could have a primary soluble layer that lasts for 12 hours and a secondary soluble layer that is the same 6 hour layer used for the first jar, thus providing bait exposure during hours 12-24. The third jar, can have a primary soluble layer that lasts for 24 hours, and a secondary layer that lasts for 6 hours, providing coverage from 24-36 hours—and so on. Other combinations (such as a bait jar with three or four bait components and layers in between) can also be used without departing from the scope of the disclosure.

### EXAMPLES

### A. Lab

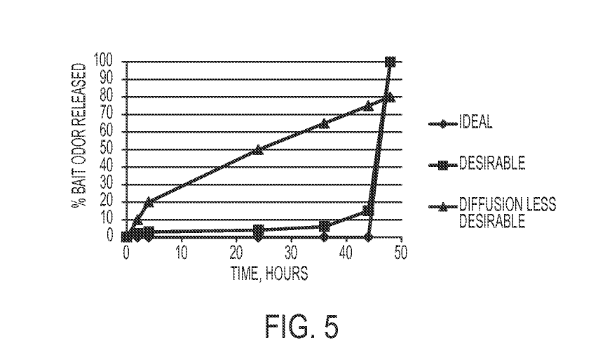

FIG. 5 is a graph that illustrates a bait odor release profile, which an ideal profile, a desirable provide and a less desirable profile over time with an indication of percentage of odor released.

### Example 1

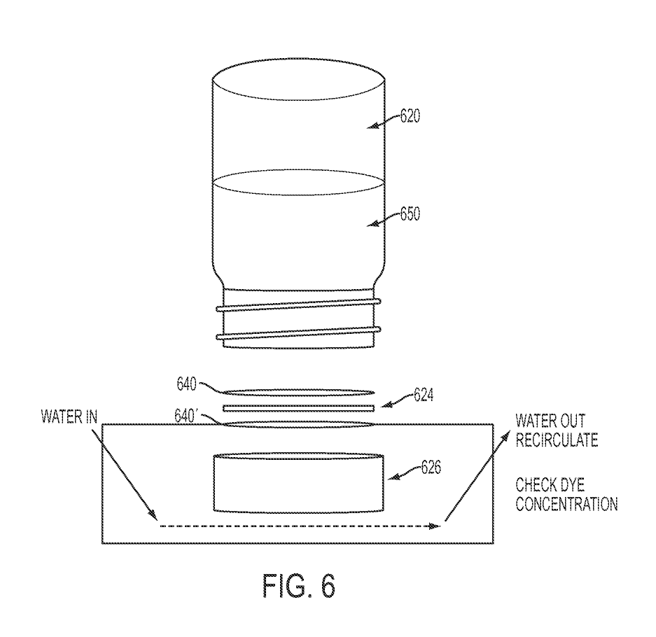

A four ounce jar with 50 g of water with blue food coloring was assembled with a 0.012 inch thick polyethylene copolymer (Lotryl® 7BA01, non-water soluble, which is a copolymer of polyethylene and butyl acrylate that can be pressed to flat sheet at 302 F.°) test film between two 0.030 thick silicone gaskets as shown in FIG. 6. The cap with 1.5″ of the center removed was tightened to provide a seal. The cap provided no support to the main body of the film. The assembly was then immersed in about 1 liter of tap water without food coloring. The water was recirculated using a peristaltic pump at a rate of 270 ml/min. A sample of approximately 3 ml was removed after 16 hours and placed in a 10 mm path length plastic cuvette. This was placed in Perkin Elmer® Lambda 20 UV-Visible Spectrometer. No dye absorbance was detected at 627 nm (peak wavelength for blue dye). The dye solution was then emptied into the recirculating water and the sample was taken and measured at an absorbance of 0.7 at 627 nm wavelength, representing the maximum release of dye at breakthrough.

### Example 2

A four ounce jar 620 with 50 g of water with blue food coloring 650 was assembled with a test film 624 of 0.013″ thick high molecular weight polyethylene oxide (Polyox™ WSR303, pressed flat at 130° C., a high molecular weight polyethylene oxide manufactured by pressed flat at 130° C. Two sheets laminated around a screen between two 0.030″ thick silicone gaskets 640, 640′ as shown in FIG. 6. The screen could be, for example, a vinyl window screen, approximately 0.010″ thick with rectangular openings about 0.030″×0.060″. The cap 626 with 1.5″ of the center removed was tightened to provide a seal. The cap provided no support to the main body of the film 624. The jar assembly was then immersed in about 1 liter of tap water without food coloring. The water was recirculated using a peristaltic pump at a rate of 270 ml/min. Samples of approximately 3 ml were removed at time intervals and placed in a 10 mm path length plastic cuvette. These were placed in Perkin Elmer UV-Visible Spectrometer and the dye absorbance was measured at 627 nm. Full breakthrough of the film was observed in less than 1 hour.

### Example 3

A four ounce jar with 50 g of water with blue food coloring was assembled with a 0.0148″ thick polyethylene oxide (Polyox WSR303) test film between two 0.030″ thick silicone gaskets as shown in FIG. 6. A cap with nine ¼″ holes drilled through it was used to partially support the film (75% area support). The cap was tightened to provide a seal. The jar assembly was then immersed in about 1 liter of tap water without food coloring. The water was recirculated using a peristaltic pump at a rate of 270 ml/min. Samples of approximately 3 ml were removed at time intervals and placed in a 10 mm path length plastic cuvette. This was placed in Perkin Elmer UV-Visible Spectrometer. The dye absorbance was measured. Significant breakthrough of the film was seen in 23 hours.

TABLE 1

| | | | Cap % | |
|---|---|---|---|---|
| | | Film | Support | Breakthrough |
| Example | Film Type | Thickness | area | time |
| 2 | PEO WSR 303 | 0.013″ | 0 | <1 hr |
| 3 | PEO WSR 303 | 0.0145″ | 75 | 23 hr |
| 4 | PEO WSR 303 | 0.0172″ | 56 | 2 hr |
| 5 | PEO WSR/20% mica | 0.0115″ | 56 | <25 min |
| 6 | PEO WSR/20% mica | 0.0135″ | 75 | <10 min (tears) |

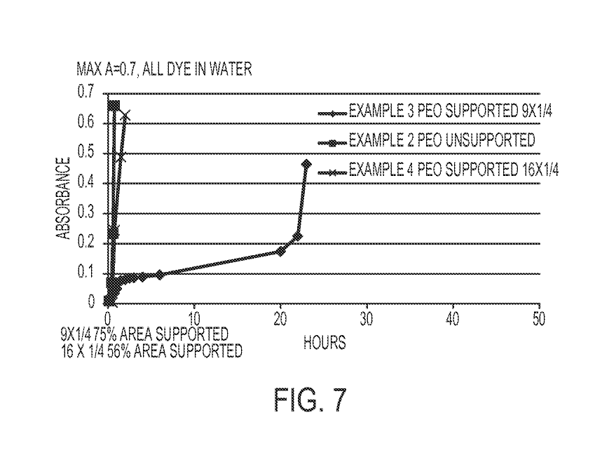

EXAMPLES 2-6 in Table 1, show the high molecular weight polyethylene oxide (PEO) even with internal reinforcement (mica) or external support cap erodes too fast for the target breakthrough time of 48 hrs. FIG. 7 illustrates blue dye absorbance observed in Examples 2-4 over a period of 50 hours.

TABLE 2
Samples in Tap Water Eheim pump

| | | Film | | Breakthrough |
|---|---|---|---|---|
| Example | Film Type | Thickness | Screen | time |
| 7 | PVA Mowiol 56- | 0.007″ | No | 27% at 25 hr |
| | 98/20% Mica | | | Diffusion only |
| 8 | PVA 26-88 | 0.012″ | Yes | 3 hr |
| 9 | PEO | 0.012″ | Yes | <6 hr |
| 10 | Gelatin mica | 0.020″ | Yes | No brk >66 hr |
| 11 | Gelatin | 0.020″ | Yes | No brk >64 hr |
| 12 | Plasticized Gelatin | 0.020″ | Yes | >96 hr |
| 13 | CW gel | 0.020″ | Yes | 2.5 hr |
| 14 | Blend 75% CW/25% | 0.020″ | Yes | 3 hr |
| | std gelatin | | | |
| 15 | Blend 60% CW/40% | 0.020″ | Yes | No brk >66 hr |
| | std gelatin | | | |
| 16 | Blend 50% CW/50% | 0.020″ | Yes | No brk >48 hr |
| | std gelatin | | | |

PVA 56-98—Mowiol 56-98 from Kuraray, 98% hydrolyzed, soluble in hot water, insoluble in cold water Example 7 Films cast and dried from 5 weight % aqueous solution.
PVA 26-88—Mowiol 26-88 from Kuraray, 88% hydrolyzed, soluble in cold water Example 8 Films cast and dried from 5 weight % aqueous solution.
Gelatin—Silver Grade Gelatin 160 Bloom from Modernist Pantry—dry sheets animal gelatin; soluble in hot water insoluble cold water (see, also, Examples 10, 11, 14-16, 18)
CW Gelatin—Instagel® from Modernist Pantry—Water soluble gelatin powder (see, also, Examples 13-16, 18).
Plasticized gelatin—Gelatin to which % 34 glycerin (Sigma Aldrich) and 8% sorbitol (D-sorbitol, TCI Inc.) by weight have been added (see, also, Example 12).
Plasticized CW gelatin—Instagel to which has been added 25% of gelatin by weight (see, also, Example 19).

EXAMPLES 7-16 in Table 2, utilized the same set-up of EXAMPLE 2 using an Eheim Universal 300 recirculating pump. The water bath was increased to 4 liters and the recirculating rate was 6 L/min to promote faster erosion of the membrane. Example 7 shows that cold water insoluble PVA (98% hydrolyzed) does not breakthrough but allows significant diffusion of the dye through the membrane which is not desirable. Example 8 and 9 show that screen support does not help classic cold water soluble polymers such as 88% hydrolyzed PVA and PEO. Examples 10-12 show that standard animal gelatin (cold water insoluble) reinforced with screen or mica does not show breakthrough in acceptable time. Example 13-16 shows that cold water soluble gel shows rapid breakthrough in fresh water and that blends of cold water soluble and standard gelatin can be used to increase the breakthrough time.

Wet Process Synthetic mica (Mica-FA1040) from Sanbao Pearl Luster Custom Mica Tech (particle size 10-40 micron) can be used. The mica is blended at 20% by weight of polymer into PEO (at 130 C) (such as in Examples 5, 6), or in solution at 20% by weight of polymer (such as in Examples 7, 10).

TABLE 3
Salt Water (35 weight % sodium chloride in tap water) with Eheim pump

| | | Film | | Breakthrough |
|---|---|---|---|---|
| Example | Film Type | Thickness | Screen | time |
| 17 | PEO | .012″ | No, 75% | 31 hr |
| | | | Cap | |
| 18 | Blend 75% CW/ | .020″ | Yes | No brk, 20% |
| | 25% std gelatin | | | diffusion 48 hr |
| 19 | CW gel plasticized | .020″ | Yes | 48 hr |

Examples 17-18 in Table 3 show effect (slower breakthrough) of salt water vs. tap water

Example 19 shows ideal combination: Cold water (“CW”) soluble gel: 100 parts by weight of Instagel to which 24 parts by weight of glycerin has been added.

It is clear that combinations of cold water soluble gelatin and standard gelatin can be used in combination with a support mechanism (either internal such as a screen or external such as a cap with perforations) to alter the breakthrough time. The actual time to release bait attractant odor will depend on the actual conditions such as temperature, salinity, and erosion forces such as current and animal attack.

It is also clear that other additives to the formulation to improve handling may be employed (such as glycerin, sorbitol other natural plasticizers or sugars can be added).

Other additives such as preservatives and antioxidants may be employed to improve the shelf life of the protective films prior to use.

Persons of skill in the art will appreciate that a number of alternatives to provide support for the film may be employed without departing from the scope of the disclosure. These support alternatives can have a variety of perforations as needed and may be rigid such as wire cloth, flexible such as nylon or polypropylene mesh, or biodegradable such as Polylactic acid, starch based polymers or similar materials.

### Preparation of Gelatin Based Samples:

19-20 g Gelatin is dissolved in hot water with stirring. If glycerin or sorbitol is added it is after this stage. The solution is stirred until all dissolved and maintained in liquid state, stirring slowly or not at all to allow any bubbles to de-gas.

8-10 g of gelatin solution is cast into a 0.060″ deep round mold of about 2″ in diameter. If a screen is used it is cut to fit inside the mold and the gel is cast over it so that the screen is immersed in the gel solution.

The part is air dried over night at room temperature. It is de-molded, inverted, and further dried to touch at room temperature.

Blends of gelatin and CW gelatin were prepared by blending the individual gelatin and CW gelatin solutions in the desired ration by weight prior to casting into mold.

### B. Field

The following results were obtained while testing the configurations in the field (i.e., ocean water).

TABLE 4

| | | 1 | | 2 | |
|---|---|---|---|---|---|
| Time (Hours) | | Sample A | Sample B | Sample A | Sample B |
| 25 | H | a little swollen | separated from | a little swollen | separated from |
| | | | screen and | | screen and |
| | | | swollen | | swollen |
| 36 | H | still intact | with hole open; | still intact | with hole, open; |
| | | | without hole just | | without hole, just |
| | | | about to open | | about to open |
| 49.5 | H | | | without hole, | without hole |
| | | | | most intact; with | about to open |
| | | | | hole, starting to | |
| | | | | seep ray from | |
| | | | | screen | |
| 58 | H | without hole, still | without hole | | |
| | | intact but | about to open | | |
| | | swelling; with | | | |
| | | hole, about to | | | |
| | | open | | | |
| 64.5 | H | | | Both intact, with | |
| | | | | hole less intact | |
| 71.5 | | | | Both intact, with | |
| | | | | hole less intact | |
| 72 | H | Open | Open | | |
| 96 | H | | | with hole open, | |
| | | | | without hole still | |
| | | | | intact | |
| 121 | H | | | without hole | |
| | | | | about to open | |
| 140 | H | | | without hole open | |

A hole, or pinprick, was provided in the container to equalize the pressure in some samples. Samples were placed in 4-6 feet of salt water in the bay.

Sample A is 100 parts by weight Instagel; 24 parts by weight glycerin. Sample B is 100 parts by weight Instagel; 24 parts by weight Glycerin; 24 parts by weight D-Sorbitol.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An assembly comprising:
a receptacle having a bottom, side walls and an opening at one end forming a cavity;
a securement component having one or more apertures configured to engage the open end of the receptacle;
a primary soluble layer having a target dissolution time,
wherein the assembly is configured to securely contain a solid material within the receptacle protected from consumption by organisms and further wherein the primary soluble layer is configured to release a water soluble material from the solid material within the receptacle.

2. The assembly of claim 1 wherein the receptacle has a threaded opening and the securement component is configured to having mating threads.

3. The assembly of claim 1 wherein a secondary soluble layer is provided having a target dissolution time different that the dissolution time for the primary soluble layer.

4. The assembly of claim 1 wherein the primary soluble layer has a target dissolution time selected from the following: 3 hours, 6 hours, 12 hours, 18 hours, 24 hours, 30 hours and 36 hours.

5. The assembly of claim 1 further comprising a mesh layer.

6. The assembly of claim 1 wherein the solid material is bait.

7. The assembly of claim 1 wherein the soluble layer has a thickness from 0.25 mm to 25 mm.

8. The assembly of claim 1 wherein the soluble layer comprises one or more of: gelatin, casein, biopolymer, plastic, cellulose acetate, polyhydroxyalkanoates, poly-butyl acetate mix, poly(lactic acid); poly(vinyl acetate); and poly(ester amide).

9. The assembly of claim 9 wherein the soluble layer further comprises one or more of poly ethylene oxide, polyacrylamide, and hydrolyzed polyacrylamide.

10. A system comprising:
a first receptacle having a bottom, side walls and an opening at one end forming a cavity;
a first securement component having one or more apertures configured to engage the open end of the receptacle;
a first primary soluble layer having a target dissolution time,
a second receptacle having a bottom, side walls and an opening at one end forming a cavity;
a second securement component having one or more apertures configured to engage the open end of the receptacle;
a second primary soluble layer having a target dissolution time,
wherein the first receptacle and second receptacle are configured to securely contain a solid material within the receptacle protected from consumption by organisms and further wherein the first primary soluble layer is configured to release a water soluble material from the solid material within the first receptacle at a first target dissolution time and the first secondary soluble layer is configured to release a water soluble material from the solid material within second receptacle at a second target dissolution time. further wherein the first target dissolution time is a time different.

11. The system of claim 10 wherein the first receptacle and second receptacle have a threaded opening and the first securement component and second securement component is configured to have mating threads.

12. The assembly of claim 10 wherein the primary soluble layer has a target dissolution time selected from the following: 3 hours, 6 hours, 12 hours, 18 hours, 24 hours, 30 hours and 36 hours.

13. The assembly of claim 12 wherein the second soluble layer has a target dissolution time different from the primary soluble layer dissolution time selected from the following: 3 hours, 6 hours, 12 hours, 18 hours, 24 hours, 30 hours and 36 hours.

14. The system of claim 10 further comprising a mesh layer.

15. The system of claim 10 wherein the solid material is bait.

16. The system of claim 10 wherein the primary soluble layer and secondary soluble material have a thickness from 0.25 mm to 25 mm.

17. The system of claim 10 wherein the soluble layer comprises one or more of: gelatin, casein, biopolymer, plastic, cellulose acetate, polyhydroxyalkanoates, poly-butyl acetate mix, poly(lactic acid); poly(vinyl acetate); and poly(ester amide).

18. A method of attracting crustaceans comprising:
selecting a soluble material having a target dissolution time;
placing a solid material in a receptacle having a bottom, side walls and an opening at one end forming a cavity;
selecting one or more soluble layers, wherein each of the one or more soluble layers has a target dissolution time; and
securing the one or more soluble material layers to the opening of the receptacle using a securement component having one or more apertures configured to engage the open end of the receptacle.

19. The method of claim 18 further comprising the steps of:
placing the assembled receptacle into a bait box; and
placing the assembled receptacle and bait box into an aquatic environment.

20. A kit comprising one or more of each of the following:
a receptacle having a bottom, side walls and an opening at one end forming a cavity;
a securement component having one or more apertures configured to engage the open end of the receptacle;
a screen sized to fit over the opening of the receptacle;
bait; and
one or more soluble layers having a target dissolution time.
